(19) United States
(12) Patent Application Publication
(10) Pub. No.: US 2011/0205453 A1
(43) Pub. Date: Aug. 25, 2011

(54) ILLUMINATION DEVICE, SURFACE ILLUMINANT DEVICE, DISPLAY DEVICE, AND TELEVISION RECEIVER

(75) Inventor: Nobuhiro Kasai, Osaka-shi (JP)

(73) Assignee: SHARP KABUSHIKI KAISHA, Osaka-shi, Osaka (JP)

(21) Appl. No.: 13/124,188

(22) PCT Filed: Jun. 22, 2009
(86) PCT No.: PCT/JP2009/061331

§ 371 Date: Apr. 14, 2011

(30) Foreign Application Priority Data
Oct. 23, 2008 (JP) 2008-273314

(51) Int. Cl. H04N 3/14; F21V 7/22; G02F 1/13357

(52) U.S. Cl. 348/790; 362/606; 349/62; 348/E03.016

(57) ABSTRACT

In a case where (i) a direction in which exit surfaces (2a) of light sources (2) face corresponding entrance surfaces (1d) of light guides (1) is assumed to be a first direction and (ii) a direction perpendicular to the first direction on the a substrate (4) is assumed to be a second direction, each of reflecting sections (7) is provided in at least part of a strip area, on the substrate (4), between the exit surfaces (2a) and the entrance surfaces (1d), the strip area having (i) a distance, equal to a distance between the exit surface (2a) and the entrance surface (1d), in the first direction, and (ii) a second distance in the second direction. This makes it possible to provide the illumination device (31) which can further improve luminous uniformity in the emission surface, even though gaps are uneven, each of which is formed between the respective exit surfaces (2a) of the light sources (2) and the respective entrance surfaces (1d), which face corresponding ones of the exit surfaces (2a), of the light guides (1).

### TECHNICAL FIELD

The present invention relates to an illumination device or a surface illuminant device which is used as a backlight of a television receiver. Moreover, the present invention relates to a display device and a television receiver each of which includes the illumination device or the surface illuminant device.

### BACKGROUND ART

In these years, a liquid crystal display device has rapidly spread instead of a cathode-ray tube (CRT). Such a liquid crystal display device is widely used in devices such as a liquid crystal television, a monitor, and a mobile phone, by taking advantage of features such as energy-saving, thin body, and lightweight. The features can be further utilized by, for example, improving an illumination device (so-called backlight) which is to be provided in back of the liquid crystal display device.

The illumination device can be mainly classified into a side light type (which is also called edge light type) and a direct type. According to a side light type illumination device, a light guide plate is provided in back of a liquid crystal display panel and a light source is provided on a lateral edge part of the light guide plate. The light source emits light, and the light is reflected by the light guide plate so that the liquid crystal display panel is indirectly and uniformly irradiated with the light. This makes it possible to provide a reduction of thickness of the illumination device, even though such an illumination device attains a low luminance. The side light type illumination device therefore is mainly applied to a small-to-medium-sized liquid crystal display for devices such as a mobile phone and a laptop computer.

According to a direct type illumination device, a light sources are provided in back of a liquid crystal display panel so that the liquid crystal display panel is directly irradiated with light. This makes it possible to attain a high luminance even with a large screen, and therefore the direct type illumination device is mainly applied to a large liquid crystal display having a size of 20 inches or more. However, a known direct type illumination device has a thickness of approximately 20 mm to 40 mm. Such a thickness interferes with further reduction of a thickness of a display.

It is possible to further reduce a thickness of a large liquid crystal display by reducing a distance between the liquid crystal display panel and the light sources. In such a case, it is necessary to increase the number of the light sources in order to attain uniformity in luminance of the illumination device. On the other hand, such increase of the number of the light sources leads to increase in cost. It is therefore demanded to develop an illumination device which is small in thickness and has excellent luminous uniformity, without increasing the number of the light sources.

Conventionally, it has been tried to enhance luminous uniformity of an illumination device by improving luminous unevenness in the vicinity of light sources.

According to a liquid crystal module disclosed in Patent Literature 1, a plurality (two) of LEDs 101 as light sources are provided along one side of a light guide 102 (see (a) of FIG. 7). Moreover, a reflection sheet 103 is provided in back of the light guide 102. Each of the LEDs 101 is fixed by a reflection tape 105, and a flexible printed circuit board 106 for LED is provided on the LED 101 and the reflection tape 105. The flexible printed circuit board 106 is fixedly connected with the LED 101 with an electrically conductive adhesive 107 (see (b) of FIG. 7).

According to the technique disclosed in Patent Literature 1, the reflection sheet 103 has a reflection surface which partially serves as diffuse reflection surfaces 103a, in order to improve luminous unevenness in the edge part in which the LEDs 101 are provided. The diffuse reflection surfaces 103a are provided in the respective vicinities of incident sections of the light guide 102 via which light from the LEDs 101 enter (see (a) of FIG. 7).

According to the configuration, each of the LEDs 101 emits light which enters the light guide 102. The light include (i) light rays L which are reflected by the reflection tape 105 before the light rays L reach the diffuse reflection surface 103a and (ii) light rays which reach the diffuse reflection surface 103a directly. The light rays L and the light lays, which reach the diffuse reflection surface 103a, are reflected diffusely and thereby dispersed. This makes it possible to reduce an amount of light which leaks out of the vicinity of the incident section of the light guide 102. Accordingly, it is possible to reduce occurrence of a difference between (i) an amount of light which leaks out of the vicinity of the incident section and (ii) an amount of light which leaks out of the other part of the light guide 102.

More specifically, the reflection sheet 103 has a silver-evaporated reflection surface 103b on which the diffuse reflection surfaces 103a are provided by forming a plurality of linear trails 103c (see (a) of FIG. 7). The diffuse reflection surfaces 103a are provided in a part of the silver-evaporated reflection surface 103b which part corresponds to the vicinity of the incident section, which is near the LEDs, of the light guide 102. The plurality of linear trails 103c are thin grooves extending in a longitudinal direction (which is perpendicular to a side of the reflection sheet 103 on which side the LEDs are provided). The plurality of linear trails 103c, which extend in the longitudinal direction, cause light to be more easily dispersed in a lateral direction (i.e., dispersed toward lateral sides of the diffuse reflection surface 103a).

### CITATION LIST

### Patent Literature

### Patent Literature 1

Japanese Patent Application Publication, Tokukai, No. 2008-147091 (Publication Date: Jun. 26, 2008)

### Patent Literature 2

Japanese Patent Application Publication, Tokukai, No. 2006-108033 (Publication Date: Apr. 20, 2006)

### Patent Literature 3

Japanese Patent Application Publication, Tokukai, No. 2006-269365 (Publication Date: Oct. 5, 2006)

### Patent Literature 4

Japanese Patent Application Publication, Tokukai, No. 2006-269364 (Publication Date: Oct. 5, 2006)

### Patent Literature 5

Japanese Patent Application Publication, Tokukaihei, No. 8-315619 (Publication Date: Nov. 29, 1996)

### SUMMARY OF INVENTION

### Technical Problem

The technique disclosed in Patent Literature 1 is directed to achieve uniformity in luminous of light emitted from the LEDs 101 into the light guide 102. However, it is not considered at all that amounts of light, which enters entrance surfaces of the respective light guides 102, become uneven in a case where a gap between (i) the respective entrance surfaces of the light guides 102 and (ii) the respective exit surfaces of the LEDs 101 is uneven. Such uneven gaps are caused by factors such as positional displacement of the light guides 102, misalignment during mounting of the LEDs 101, manufacturing tolerances of the light guides 102 and the LEDs 101, and thermal expansion deviations caused by heat generated by the LEDs. That is, the technique disclosed in Patent Literature 1 fails to consider luminous unevenness which occurs due to unevenness of a gap between (i) the respective entrance surfaces of the light guides 102 and (ii) the respective exit surfaces of the LEDs 101. It is therefore difficult to sufficiently improve luminous unevenness so as to attain a high quality display only with the configuration disclosed in Patent Literature 1.

The following describes details of luminous unevenness which occurs in a case where a gap between (i) respective entrance surfaces of light guides and (ii) respective exit surfaces of LEDs, which are light sources, is uneven.

FIG. 8 is a schematic view illustrating a gap between (i) respective entrance surfaces of light guides and (ii) respective exit surfaces of LEDs, which are light sources, in a conventional illumination device.

FIG. 9 is a partial magnified view of the conventional illumination device shown in FIG. 8. FIG. 9 schematically illustrates optical behavior of light emitted from a light source.

A gap G is a space which reside between (i) respective entrance surfaces 201d of light guides 201 and (ii) respective exit surfaces 202a of LED light sources 202 (see FIG. 8). The gaps G have respective widths which are uneven due to factors such as positional displacement of the light guides 201, misalignment during mounting of the LED light sources 202, manufacturing tolerances of the light guides 201 and the LED light sources 202, and thermal expansion deviations caused by heat generated by the LED light sources 202. Accordingly, the widths of the gaps G are to be different for each of combinations of (i) the light guides 201 and (ii) corresponding ones of the LED light sources 202.

Moreover, light emitted from each of the exit surfaces 202a is partially reflected by an LED substrate 204 having a substantial reflectance of approximately 50% to 60%. Accordingly, weakened light is to enter corresponding one of the light guides 201 via corresponding ones of the entrance surfaces 201d (see FIG. 9).

According to the configuration, in a case where the gap G between the entrance surface 201d of the light guide 201 and the exit surface 202a of the LED light source 202 is large, an amount of light, which is to be reflected by the LED substrate 204, is increased. This causes a loss in amount of the light to be increased by the reflection, and accordingly the amount of the light entering the entrance surface 201d is decreased. On the other hand, in a case where the gap G is small, an amount of light, which is emitted from the LED light source 202 and directly enters the entrance surface 201d, becomes large. Such a difference between amounts of the light entering the entrance surface 201d causes luminous unevenness.

The present invention is accomplished in view of the problems, and its object is to provide an illumination device which can further improve luminous uniformity in an emission surface, even though uneven gaps exist between (i) the entrance surfaces of the respective light guides and (ii) the exit surfaces, each of which faces a corresponding one of the entrance surfaces, of the respective light sources.

Another object of the present invention is to provide a surface illuminant device which can further improve luminous uniformity in the emission surface, by incorporating therein the illumination device.

Moreover, yet another object of the present invention is to provide a liquid crystal display device and a television receiver each of which achieves excellent display quality by incorporating therein the surface illuminant device serving as a backlight.

### Solution to Problem

In order to attain the objects, an illumination device of the present invention includes: a plurality of combinations each of which includes (i) a light source having an exit surface and (ii) a light guide, having an entrance surface, which causes light emitted from the light source to diffuse and have a surface emission; a substrate on which the light sources are provided; and a reflecting section provided in at least part of a strip area, on the substrate, between the exit surface and the entrance surface, the strip area having (i) a first distance, equal to a distance between the exit surface and the entrance surface, in a first direction and (ii) a second distance in a second direction, the first direction extends in a direction in which the exit surface and the entrance surface face each other, and the second direction being perpendicular to the first direction on the substrate.

According to the configuration, the reflecting sections provided on the substrate can control occurrence of a difference between respective amounts of light entering the entrance surfaces of the respective light guides, even though a gap between the respective entrance surfaces and (ii) the respective exit surfaces is uneven. Note that such uneven gaps occur due to factors such as positional displacement of the light guides, misalignment during mounting of the light sources, manufacturing tolerances of the light guides and the light sources, and thermal expansion deviations caused by heat generated by the light sources.

That is, the reflecting section is provided in a region on the substrate, where the light emitted from the light source is reflected. This makes it possible to suppress a loss, which is caused by the substrate, in amount, of light entering the entrance surface of the light guide. This makes it possible to provide an illumination device which can further improve luminous uniformity in the emission surface, even though uneven gaps exist between (i) the entrance surfaces and (ii) the exit surfaces, each of which faces a corresponding one of the entrance surfaces. That is, it is possible to provide an illumination device which allows for (i) a margin of mounting and (ii) a margin of manufacturing tolerance of the light guides and the light sources.

The above conventional technique, in which no reflecting section is provided, employs a substrate which has a reflectance of approximately 50% to 60%. Accordingly, in a case where a gap between respective exit surfaces of light sources and respective entrance surfaces of light guides is uneven, (i) amounts of first light which directly enters the entrance surfaces become uneven and (ii) amounts of second light which is reflected by the substrate and then enters the entrance surfaces become uneven. Note that each first light and each second light partially constitute the light, which is emitted from a corresponding one of the exit surfaces.

(i) The first light, which is emitted from the each exit surface and directly enters a corresponding entrance surface, has no loss in amount of light, whereas (ii) the second light, which is reflected by the substrate and then enters the corresponding entrance surface, has a large loss in amount of light, unless a reflectance of the substrate is increased.

According to the configuration of the conventional technique, the loss in amount of light is significant due to the substrate. Accordingly, it is difficult to provide an illumination device which can further improve luminous uniformity in an emission surface.

On the other hand, according to the present invention, the reflecting section is provided in somewhere in the strip area which (i) has the second distance in the second direction of the light guide and (ii) lies with respect to the entrance surface of the light guide. This makes it possible to suppress the loss in amount of light which is conventionally caused by reflection. Moreover, it is of course possible to maximally suppress the loss in amount of light by providing the reflecting section over the entire strip area.

Note that the reflecting section can be provided on the substrate by a method such as (i) a method in which soldering is carried out in place with the use of a solder resist or (ii) a method in which a patterning is carried out, with respect to a thin film obtained by evaporating, printing, or plating a material such as silver or aluminum which has a high reflectance so that only the thin film which is in place is left. However, the present invention is not limited to the methods. It is therefore possible to use any method, provided that the method allows a material having a high reflectance to be provided in place.

According to the illumination device of the present invention, it is preferable that the at least part of the strip area is in an area defined by connecting four points, (i) two of which are on the substrate and correspond to both ends of the entrance surface in the second direction and (ii) two of which are on the substrate and correspond to both ends of the exit surface in the second direction.

According to the configuration, the reflecting sections are provided in an area of the substrate in which area light, which is emitted from the light source, is easily reflected. This makes it possible to more efficiently suppress occurrence of a difference between respective amounts of light entering the respective entrance surfaces of the light guides. Accordingly, it is possible to provide an illumination device which can efficiently improve luminous uniformity in the emission surface.

According to the illumination device of the present invention, it is preferable that the at least part of the strip area is in an area defined by two lines, (i) one of which extends to the entrance surface, in the first direction, from a corresponding one of two points on the substrate which corresponds to one of both ends of the exit surface in the second direction and (ii) the other of which extends to the entrance surface, in the first direction, from the other of the two points on the substrate which corresponds to the other of the both ends of the exit surface.

According to the configuration, the reflecting section is provided in an area of the substrate on which area the light, which is emitted from the light source, is most likely to be reflected. This makes it possible to most effectively suppress occurrence of a difference between amounts of light entering the respective entrance surfaces of the light guides. Accordingly, it is possible to provide an illumination device which can further efficiently improve luminous uniformity in the emission surface.

According to the illumination device of the present invention, it is preferable that the light guide has (i) a light emitting section having an emission surface and (ii) a light guide section which guides the light from the light source toward the light emitting section; and the exit surfaces are provided so as to be two-dimensionally juxtaposed to each other on the surface of the substrate.

According to the configuration, the exit surfaces of the respective light sources are provided so as to be two-dimensionally juxtaposed to each other on the substrate. This makes it possible to provide an illumination device which can further improve luminous uniformity in the emission surface which is made up of emission surfaces of the light guides.

According to the illumination device of the present invention, it is preferable that ones of the light guides, which are provided so as to be two-dimensionally juxtaposed to each other, are provided in one of two directions so that a light emitting section of one of any adjacent two light guides is provided above a light guide section of the other of the any adjacent two light guides.

According to the illumination device of the present invention, it is preferable that the light guides which (i) are provided so as to be two-dimensionally juxtaposed to each other and (ii) are provided so that any adjacent ones of the light guides do not overlap each other.

According to the configuration, the light sources and the light guides are provided so that the exit surfaces of the respective light sources face corresponding ones of the entrance surfaces of the respective light guides. Accordingly, in a case where the light sources are provided so as to be two-dimensionally juxtaposed to each other on the substrate, the light guides are also provided so as to be two-dimensionally juxtaposed to each other.

According to the configuration, therefore, the light sources and the light guides are provided so as to be two-dimensionally juxtaposed to each other on the substrate. This allows the emission surfaces of the respective light guides to define a large uniplanar emission surface.

Accordingly, it is possible to provide an illumination device which can further improve luminous uniformity in the emission surface.

According to the illumination device of the present invention, it is preferable that each of the light sources is an LED which is provided on the substrate.

According to the configuration, the light-emitting diode (LED), which is a point light source, is used as the light source. This makes it possible to provide an illumination device which has a wide color reproduction range.

According to the illumination device of the present invention, it is preferable that the reflecting section and a wiring pattern of the substrate are formed by patterning a layer made of an identical material.

In this case, the reflecting section is not provided independently but is provided by carrying out the patterning, concurrently with the forming of the wiring pattern on the substrate, in the manufacturing process of the substrate onto which the light sources are mounted. Further, a material identical to that for the wiring pattern on the substrate can be used to form the reflecting section. This makes it possible to accurately and easily provide the reflecting section, on the substrate, in place where the reflecting section should be provided.

Note that a material used as the reflecting section is not limited to a specific one, provided that the material achieves (i) a high reflectance and (ii) a low electric resistance when the material is used as the wiring pattern, when the material is used as the reflecting section.

According to the illumination device of the present invention, it is preferable that the reflecting sections are consecutively and linearly provided along the light guides which are provided in the second direction.

According to the configuration, it is possible to suppress the amount of light reflected by the substrate. This allows the effective suppression of occurrence of a difference between respective amounts of light entering the entrance surfaces of the respective light guides. This makes it possible to provide an illumination device which can further improve luminous uniformity in the emission surface.

Moreover, in a case where the reflecting sections are formed by patterning, the reflecting sections can be patterned so as to be consecutively and linearly provided along the light guides which are provided in the second direction. It is therefore not necessary to carry out a fine patterning for forming the reflecting sections. That is, the reflecting sections have simple and consecutive shape, and therefore there hardly occurs a problem, such as positional displacement in forming the reflecting sections due to an error in patterning. This makes it possible to further suppress an effect of luminous unevenness caused by inaccurate patterning.

According to the illumination device of the present invention, it is preferable that the reflecting section has a width, in the first direction, which is set so as to be larger than a sum of the first distance and a maximum tolerance of the first distance.

According to the configuration, the reflecting sections are provided by taking into consideration the maximum tolerance of the distance between the exit surface and the entrance surface. This allows the illumination device to deal with gaps respectively having any of all possible distances (distances in the first direction). This makes it possible to suppress, more efficiently, occurrence of a difference between amounts of light entering the entrance surfaces of the respective light guides. Accordingly, it is possible to provide an illumination device which can further improve uniformity of luminance in the emission surface.

According to the illumination device of the present invention, it is preferable that a reflection sheet is provided in the light guide so as to cover a surface which is opposite to the emission surface.

According to the configuration, the reflection sheet reflects the light, which leaks out of the surfaces opposite to the emission surface of the light guide, so as to return the light to the light guides. Each of the reflection sheets therefore serves as improving the light use efficiency of a corresponding one of the light guides.

According to the configuration, therefore, it is possible to provide an illumination device which achieves high light use efficiency.

According to the illumination device of the present invention, it is preferable that the reflection sheet is a double-sided reflection sheet.

According to the configuration, it is possible to further improve the light use efficiency of each of the light guides.

In particular, in a case where the illumination device is a so-called tandem type illumination device, the double-sided reflection sheet serves as at least partially reflecting light, which leaks out of an upper surface (a surface on the emission surface side) of one of the any adjacent two light guides toward a back surface of the other of the any adjacent two light guides, so as to return the light to the one of the any adjacent two light guides. This makes it possible to improve light use efficiency of each of the light guides.

Note that a general light guide causes light, which is emitted from a light source, to be subjected to repeated total reflections on inner surfaces of the light guide so that the light is guided toward an emission surface. In contrast, the light, which enters the upper surface at a critical angle of total reflection or smaller, leaks outside (i.e., leaks toward the other of the any adjacent two light guides) without being subjected to a total reflection on the upper surface of the one of the any adjacent two light guides. Note that the critical angle of total reflection is determined in accordance with a material of the light guide. In view of the circumstances, the double-sided reflection sheet is used to at least partially reflect the light, which leaks out of the upper surfaces of the light guide, so as to at least partially return the light toward the light guide.

Therefore, in a case where the reflection sheets are the double-sided reflection sheets, it is possible to suppress occurrence of a difference between respective amounts of light entering the entrance surfaces of the respective light guides, even in a case where a gap between the respective entrance surfaces of the light guides and the respective exit surfaces of the light sources is uneven. Accordingly, it is possible to provide an illumination device which can further improve luminous uniformity in the emission surface.

According to the illumination device of the present invention, it is preferable that the reflection sheet is attached to the light guide via an adhesive member.

In a case where there is a gap between the reflection sheet and the back surface of the light guide, luminous efficiency is decreased. This is because a loss of light becomes greater than a case where there is no gap. The luminous efficiency can be therefore further improved by adhering the reflection sheet to the back surface of the light guide via the adhesive member.

Note that, the reflection sheet can be bonded, with the adhesive member, on an edge part of the surface opposite to the emission surface of the light guide, in order to improve the luminous efficiency by adhering the reflection sheet to the back surface of the light guide.

With the configuration, it is possible to provide an illumination device which allows an improvement in luminous efficiency.

In order to attain the object, a surface illuminant device of the present invention in which an optical member is provided on an emission surface of the illumination device.

According to the configuration, the optical member is provided on the uniplanar emission surface of the illumination device. The uniplanar emission surface is made up of emission surfaces of the respective light guides. For example, a diffusing plate which has a thickness of approximately 2 mm to 3 mm and is provided so as to be away, by several millimeters, from the illumination device can be employed as the optical member. Note, however, that the thickness of the diffusing plate and the distance by which the diffusing plate is away from the illumination device are not limited to those described above.

Moreover, it is possible to provide, on the upper surface of the diffusing plate, for example, a multi-functional optical sheet such as a diffusing sheet having a thickness of approximately several hundreds micrometers, a prism sheet, or a polarizing reflection sheet so as to secure luminous uniformity which is sufficient for the surface illuminant device to carry out its function. The thickness and the configuration are merely illustrative, and the present invention is therefore not limited to these.

With the configuration, it is possible to provide a surface illuminant device which can further improve luminous uniformity in the emission surface.

In order to attain the object, a display device of the present invention includes: the surface illuminant device;

and a display panel which carries out a display with use of light emitted from the surface illuminant device.

According to the configuration, the display device includes the surface illuminant device which has the emission surface with excellent luminous uniformity. This makes it possible to provide a display device with excellent display quality.

According to the display device of the present invention, it is preferable that the display panel is a liquid crystal panel in which liquid crystal is sealed between a pair of substrates.

According to the configuration, the display panel is a liquid crystal panel. This makes it possible to provide a display device which is thin and has excellent display quality.

In order to attain the object, a television receiver of the present invention includes the display device.

With the configuration, it is possible to provide a television receiver which is thin and has excellent display quality.

### Advantageous Effects of Invention

According to the illumination device of the present invention as described above, a reflecting section is provided in at least part of a strip area, on the substrate, between the exit surface and the entrance surface, the strip area having (i) a first distance, equal to a distance between the exit surface and the entrance surface, in a first direction and (ii) a second distance in a second direction, the first direction extends in a direction in which the exit surface and the entrance surface face each other, and the second direction being perpendicular to the first direction on the substrate.

As described above, the surface illuminant device of the present invention includes the optical member which is provided on the emission surface of the illumination device.

As described above, the display device of the present invention includes the surface illuminant device; and the display panel which carries out a display with use of light emitted from the surface illuminant device.

As described above, the television receiver of the present invention includes the display device which is provided with the liquid crystal panel.

It is therefore possible to provide an illumination device which can further improve luminous uniformity in the emission surface, even in a case where uneven gaps exist between (i) the exit surfaces of the respective light sources and (ii) the entrance surfaces, each of which faces a corresponding one of the exit surfaces, of the respective light guides.

It is possible to provide a surface illuminant device which can further improve luminous uniformity in the emission surface, by providing the surface illuminant device with the illumination device.

It is possible to provide a display device with excellent display quality by providing the display device with the surface illuminant device which has the emission surface with excellent luminous uniformity.

It is possible to provide a television receiver which is thin and has an excellent display quality by providing the television receiver with the display device including the liquid crystal panel.

### BRIEF DESCRIPTION OF DRAWINGS

FIG. 1 is a lateral view illustrating a configuration of a liquid crystal display device included in a television receiver of an embodiment in accordance with the present invention.

FIG. 2 is a partial magnified view of an illumination device included in the television receiver of the embodiment in accordance with the present invention, in which optical behavior of light emitted from a light source is schematically illustrated.

FIG. 3 is a plain view, from an emission surface side, illustrating an illumination device included in the television receiver of the embodiment in accordance with the present invention.

FIG. 4 is a view in which (a), (b), and (c) illustrate examples of a shape of a reflecting section provided in an illumination device included in the television receiver of the embodiment in accordance with the present invention.

FIG. 5 is a plain view, from an emission surface side, illustrating an illumination device included in a television receiver of another embodiment in accordance with the present invention.

FIG. 6 is a cross-sectional view of the illumination device taken on line A-A of FIG. 5.

FIG. 7 is a view illustrating a conventional illumination device, where (a) illustrates a light source part viewed from an emission surface side and (b) is a cross-sectional view of the light source part.

FIG. 8 is a lateral view schematically illustrating a configuration of a conventional illumination device.

FIG. 9 is a view schematically illustrating optical behavior of light emitted from a light source of the conventional illumination device shown in FIG. 8.

### DESCRIPTION OF EMBODIMENTS

The following describes details of embodiments which exemplify the present invention with reference to drawings. Note, however, that the description of dimensions, materials, shapes, their relative locations etc. in the embodiments is not intended to limit the scope of the invention only to them but are intended to merely exemplify the present invention, unless otherwise specifically described.

The following describes details of a liquid crystal panel as an example of a display panel.

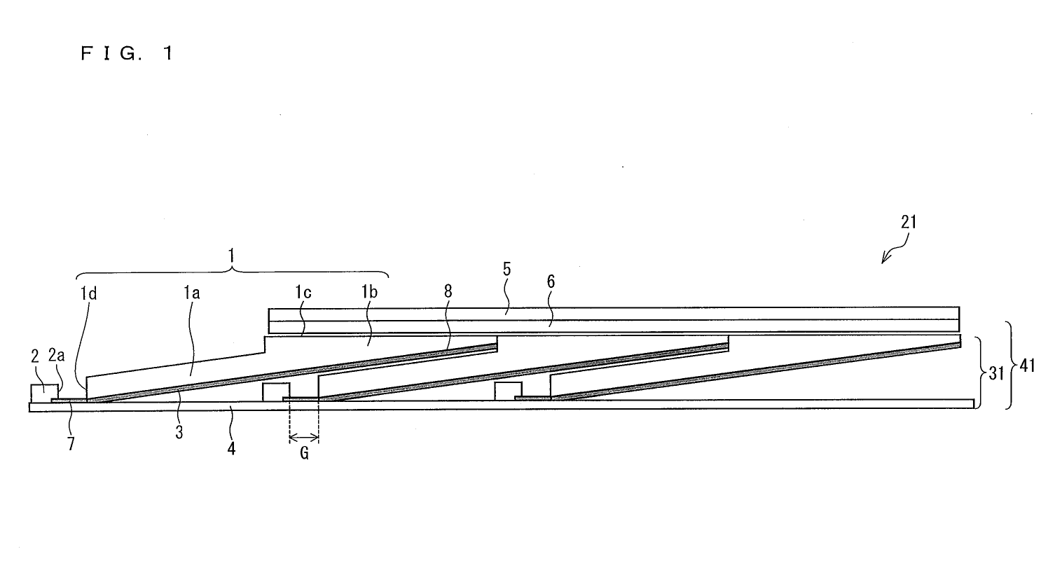

A television receiver of an embodiment in accordance with the present invention includes (i) a surface illuminant device in which luminous uniformity is further improved and (ii) a liquid crystal panel. This allows the television receiver to be thin and have a good display quality. The following describes the surface illuminant device and the liquid crystal panel, that is, a liquid crystal display device included in the television receiver, with reference to FIGS. 1 through 6.

### Embodiment 1

FIG. 1 is a lateral view schematically illustrating a configuration of a liquid crystal display device 21 included in a television receiver of an embodiment in accordance with the present invention.

The liquid crystal display device 21 includes (i) a liquid crystal display panel 5 and (ii) a surface illuminant device 41 which includes an illumination device 31 serving as a backlight for emitting light toward the liquid crystal display panel 5. The illumination device 31 includes a plurality of combinations each of which includes a light guide 1 and a light source 2.

The light guide 1 has a light guide section la and a light emitting section 1b. The light guide section 1a causes light emitted from the light source 2 to be guided toward the light emitting section 1b. The light emitting section 1b causes a surface emission from an emission surface 1c of the light emitting section 1b. The light guides 1 are provided so as to be adjacent to each other. Moreover, the light guides 1 are provided so that a light emitting section 1b of one of any adjacent two light guides 1 is provided above a light guide section 1a of the other of the any adjacent two light guides 1. This allows the emission surfaces 1c to provide a large uniplanar emission surface.

Note that a reflection sheet 3 is provided on each back surface (i.e., a surface which is opposite to the emission surface 1c) of the light guides 1. Moreover, according to the configuration, the emission surface 1c faces a back surface of an optical member 6. The back surface of the optical member 6 is irradiated with light emitted from the emission surface 1c.

The surface illuminant device 41 (backlight) further includes (i) a substrate 4 on which the light sources 2 are provided, (ii) the optical member 6 which is provided in back (opposite side of a display face) of the liquid crystal display panel 5, and (iii) a reflecting section 7 which is provided on the substrate 4 in a gap G between the respective light guides 1 and the respective light sources 2. Note that such a gap G is formed between the respective entrance surfaces 1d of the light guides 1 and the respective exit surfaces 2a. Each of the entrance surfaces 1d and a corresponding one of the exit surfaces 2a face each other. Details of how to provide the reflecting sections 7 in the respective gaps G will be described later.

The following describes details of luminous unevenness caused by unevenness of the gaps G.

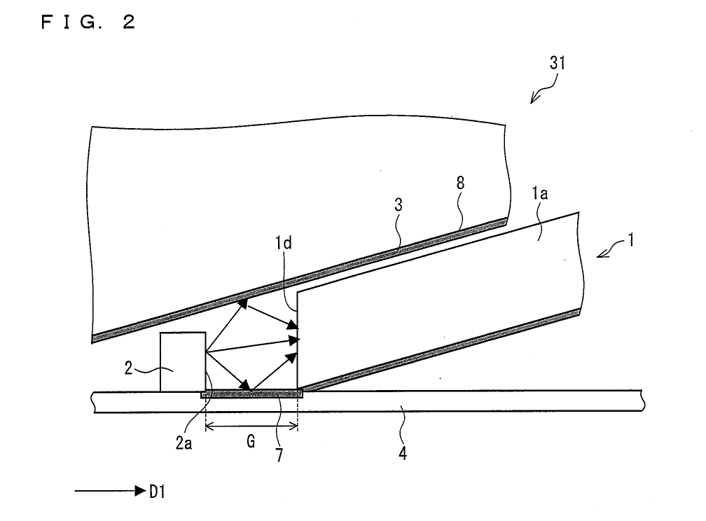

FIG. 2 is a partially enlarged view of the illumination device 31 included in the television receiver of an embodiment in accordance with the present invention, in which optical behavior of light emitted from the light source is schematically illustrated.

As described above, the gaps G shown in FIG. 2 become uneven due to factors such as positional displacement of the light guides 1, misalignment during mounting of the light sources 2, manufacturing tolerances of the light guides 1 and the light sources 2, and thermal expansion deviations caused by heat generated by the light sources 2.

In a case where a gap G between the respective exit surfaces 2a of the light sources 2 and the respective entrance surfaces 1d of the light guides 1 becomes uneven due to the above reasons, (i) amounts of first light, which directly enters the entrance surfaces 1d become uneven and (ii) amounts of second light which is reflected by the substrate 4 and then enters the entrance surfaces 1d become uneven. Note that each first light and each second light partially constitute the light which is emitted from a corresponding one of the exit surfaces 2a.

In a case of employing a substrate 4 which has no reflecting section 7 (whose details are described later) and whose reflectance falls in a range of approximately 50% to 60%, (i) first light, which is emitted from each exit surface 2a and directly enters a corresponding entrance surface 1d, has no loss in amount of light, whereas (ii) second light, which is reflected by the substrate 4 and then enters the corresponding entrance surface 1d, has a large loss in amount of light, unless a reflectance of the substrate 4 is increased.

According to the configuration, the effect of the substrate 4 on the loss in amount of light is significant. It is therefore difficult to provide an illumination device in which luminous uniformity in an emission surface is further improved.

That is, the unevenness of the gaps G causes the emission surface to have luminous unevenness.

More specifically, in a case where the gap G between (i) the entrance surface 1d of the light guide 1 and (ii) the exit surface 2a of the light source 2 is large, an amount of light reflected by the substrate 4 is increased. Consequently, an amount of light which enters the entrance surface 1d is decreased. On the other hand, in a case where the gap G between (i) the entrance surface 1d of the light guide 1 and (ii) the exit surface 2a of the light source 2 is small, an amount of light reflected by the substrate 4 is decreased and amount of light, which is emitted from the light source 2 and then directly enters the entrance surface 1d, is increased. The amount of the light which enters the entrance surface 1d of the light guide 1 thus changes in accordance with a distance of the gap G.

<Reflecting Section>

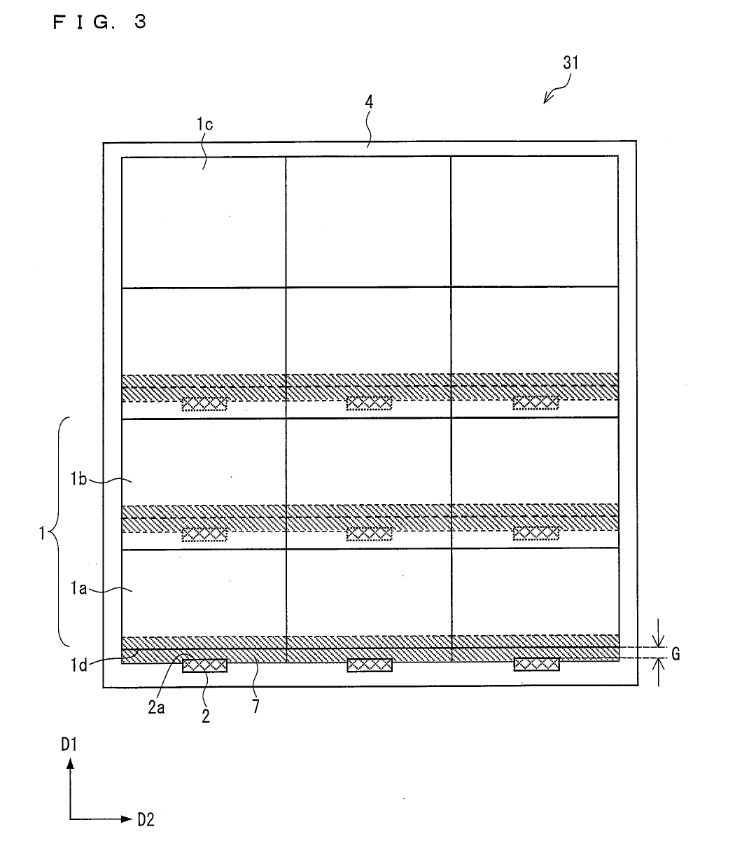

FIG. 3 is a plain view illustrating the illumination device 31 obtained when viewed from an emission surface 1c side. Note that the reflection sheet 3 is omitted in FIG. 3 in order for FIG. 3 not to be complicated.

The illumination device 31 is a tandem type illumination device in which any adjacent two of the light guides 1 are provided so that a light emitting section 1b of one of the any adjacent two light guides 1 is provided above a light guide section 1a of the other of the any adjacent two light guides 1 (see FIGS. 2 and 3).

Note that a first direction D1 is defined by a direction in which the light emitting section 1b of the one of the any adjacent two light guides 1 is provided above the light guide section 1a of the other of the any adjacent two light guides 1. That is, the first direction D1 is a direction in which an exit surface 2a of each of the light sources 2 faces an entrance surface 1d of a corresponding one of the light guides 1. Note also that a direction which intersects (at substantially right angles) with the first direction D1 on the substrate 4 is defined as a second direction D2 (see FIGS. 1 and 3).

According to the present embodiment, the reflecting sections 7 are consecutively and linearly provided in the second direction D2 (see FIG. 3). However, how the reflecting sections 7 are provided is not limited to this. The reflecting sections 7 can be therefore at least partially provided in a particular area, as described later.

Note that, according to the illumination device 31, it is preferable that (i) each of the light guides 1 has (a) a light emitting section 1b having an emission surface 1c and (b) a light guide section 1a which guides the light from the light source 2 toward the light emitting section 1b and (ii) the exit surfaces 2a are provided so as to be two-dimensionally juxtaposed to each other on the surface of the substrate 4.

The exit surfaces 2a of the respective light sources 2 are provided so as to be two-dimensionally juxtaposed to each other on the substrate 4 (see FIG. 3). This makes it possible to provide an illumination device 31 which can further improve luminous uniformity in the emission surface made up of the emission surfaces 1c of the respective light guides 1.

Moreover, according to the illumination device 31, it is preferable that ones of the light guides 1, which are provided so as to be two-dimensionally juxtaposed to each other, are provided in one of two directions so that a light emitting section 1b of one of any adjacent two light guides 1 is provided above a light guide section 1a of the other of the any adjacent two light guides 1.

Each of the exit surfaces 2a of the light sources 2 faces a corresponding one of the entrance surfaces 1d of the light guides 1 (see FIGS. 1 through 3). Since the light sources 2 are thus provided so as to be two-dimensionally juxtaposed to each other on the substrate 4, the light guides 1 are also provided so as to be two-dimensionally juxtaposed to each other in a similar manner.

Accordingly, (i) the light sources 2 and the light guides 1 are provided so as to be two-dimensionally juxtaposed to each other on the substrate 4 and (ii) it is possible that the emission surfaces 1c of the respective light guides 1 define the large uniplanar emission surface. This makes it possible to provide an illumination device 31 which can further improve luminous uniformity in the emission surface.

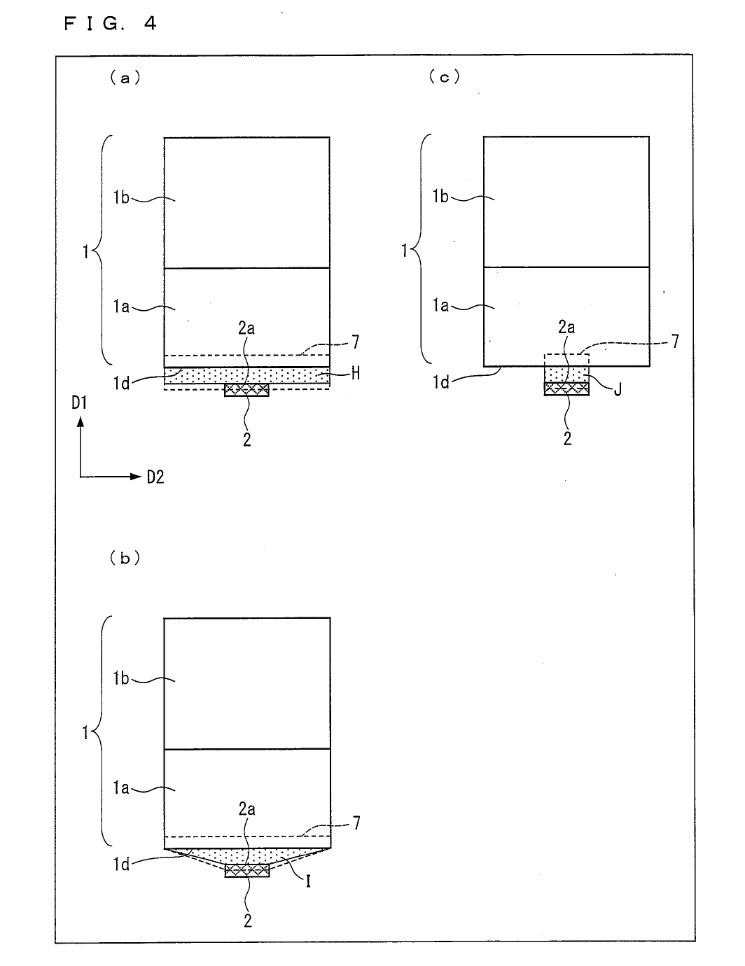

FIG. 4 is a view illustrating exemplifications as to (i) a shape of a reflecting section 7 and (ii) an area where the reflecting section 7 is provided in the illumination device 31.

Note that the substrate 4 is omitted in FIG. 4 in order for FIG. 4 not to be complicated.

(a) of FIG. 4 shows that a strip area H is located, on the substrate 4 in the illumination device 31, between the exit surface 2a and the entrance surface 1d and the strip area H has (i) a first distance equal to a distance between the exit surface 2a and the entrance surface 1d and (ii) a second distance (width) in the second direction D2.

The reflecting section 7 is at least partially provided in the strip area H. Accordingly, the reflecting sections 7 provided on the substrate 4 can suppress occurrence of a difference between respective amounts of light entering the entrance surfaces 1d of the respective light guides 1, even though the gaps G become uneven due to factors such as positional displacement of the light guides 1, misalignment during mounting of the light sources 2, manufacturing tolerances of the light guides 1 and the light sources 2, and thermal expansion deviations caused by heat generated by the light sources 2.

That is, the reflecting section 7 is provided in a region, on the substrate 4, where the light emitted from the light source 2 can be reflected. This makes it possible to suppress a loss, which is caused by the substrate 4, in amount of light entering the entrance surface 1d of the light guide 1. This makes it possible to provide an illumination device 31 which can further improve luminous uniformity in the emission surface, even though the gaps G are uneven. That is, it is possible to provide an illumination device 31 which allows for (i) a margin of mounting and (ii) a margin of manufacturing tolerance of the light guides 1 and the light sources 2.

(b) of FIG. 4 illustrates an area I, in the illumination device 31, defined by connecting four points (i) two of which are on the substrate 4 and correspond to both ends of the exit surface 2a in the second direction D2 and (ii) two of which are on the substrate 4 and correspond to both ends of the entrance surface 1d in the second direction D2

It is preferable that the reflecting section 7 is at least partially provided in the area I.

According to the configuration, the reflecting section 7 is provided in the area I of the substrate 4 in which area I light emitted from the light source 2 is more likely to be reflected. This makes it possible to more efficiently suppress occurrence of a difference between respective amounts of light entering the entrance surfaces 1d of the respective light guides 1. Accordingly, it is possible to provide an illumination device 31 which can efficiently improve luminous uniformity in the emission surface.

(c) of FIG. 4 illustrates an area J, in the illumination device 31, which is defined by two lines, (i) one of which extends to the entrance surface 1d, in the first direction D1, from a corresponding one of two points on the substrate 4 which corresponds to one of both ends of the exit surface 2a in the second direction D2 and (ii) the other of which extends to the entrance surface 1d, in the first direction D1, from the other of the two points on the substrate 4 which corresponds to the other of the both ends of the exit surface 2a.

The area J is an area in which light emitted from the light source 2 is most likely to be reflected. It is therefore preferable to select the area J in order to minimize the reflecting section 7.

According to the configuration, it is possible to most effectively suppress occurrence of a difference between respective amounts of light entering the entrance surfaces 1d of the respective light guides 1. Moreover, it is possible to provide an illumination device 31 which can efficiently improve luminous uniformity in the emission surface. Moreover, the reflecting section 7 is provided, by taking into consideration a maximum distance of the uneven gaps G, so as to partially cover (i) a bottom surface of the light source 2 and (ii) a bottom surface of the light guide section 1a of the light guide 1 (see FIG. 4). This allows the reflecting section 7 to sufficiently cover the gap G.

That is, it is preferable that the reflecting section 7 has a width, in the first direction D1, which is set so as to be larger than a sum of the first distance and a maximum tolerance of the first distance (see FIGS. 2 through 4).

According to the configuration, it is possible to more efficiently occurrence of a difference between respective amounts of light entering the entrance surfaces 1d of the respective light guides 1. Moreover, it is possible to provide an illumination device 31 which can further improve luminous uniformity in the emission surface.

According to the present embodiment, the reflecting sections 7 are consecutively and linearly provided along the light guides 1 which are provided in the second direction D2 (see FIG. 3). This allows the most effective suppression of occurrence of a difference between respective amounts of light entering the entrance surfaces 1d of the respective light guides 1.

With the arrangement, it is possible to minimize the amount of light reflected by the substrate 4. This allows the most effective suppression of occurrence of a difference between respective amounts of light entering the entrance surfaces 1d. This makes it possible to provide an illumination device 31 which can further improve luminous uniformity in the emission surface.

Moreover, in a case where the reflecting sections 7 are formed by patterning, the reflecting sections 7 can be patterned so as to be consecutively and linearly provided along the light guides 1 which are provided in the second direction D2. It is therefore not necessary to carry out a fine patterning for forming the reflecting sections 7. That is, the reflecting sections 7 have simple and consecutive shape, and therefore there hardly occurs a problem such as positional displacement in forming the reflecting sections 7 due to an error in patterning. This makes it possible to further suppress an effect of luminous unevenness caused by inaccurate patterning.

The following describes details of a method for providing the reflecting section 7.

The reflecting section 7 can be provided on the substrate 4 by a method such as (i) a method in which soldering is carried out in place with the use of a solder resist or (ii) a method in which a patterning is carried out, with respect to a thin film obtained by evaporating, printing, or plating a material such as silver or aluminum which has a high reflectance, so that only the thin film which is in place is left. However, the present embodiment is not limited to the methods. It is therefore possible to use any method, provided that the method allows a material having a high reflectance to be provided in place.

When taking into consideration the productivity in manufacturing of the illumination device 31, it is preferable to form the reflecting section 7 and a wiring pattern of the substrate 4 by patterning a layer containing identical materials.

In this case, the reflecting section 7 is not provided independently but is provided by carrying out the patterning, concurrently with the forming of the wiring pattern on the substrate 4 onto which the light sources 2 are mounted. Further, a material identical to that for the wiring pattern on the substrate 4 is used to form the reflecting section 7. This makes it possible to easily and accurately provide the reflecting section 7, on the substrate 4, in place where the reflecting section 7 should be provided.

Note that a material used as the reflecting section 7 is not limited to a specific one, provided that the material achieves (i) a high reflectance and (ii) a low electric resistance when the material is used as the wiring pattern, when the material is used as the reflecting section 7.

According to the present embodiment, the reflecting section 7 is made of silver which has a high reflectance and can be used also as a material of the wiring pattern. The reflecting section 7 and the wiring pattern were concurrently formed by carrying out the following processes (i) through (iv) in this order: (i) depositing a silver thin film on a whole surface of the substrate 4 with the use of a method such as evaporation, (ii) applying a photosensitive material (photoresist) onto the silver thin film, (iii) carrying out pattern exposure and development processes with respect to the photosensitive material (photoresist), and (iv) concurrently patterning the reflecting section 7 and the wiring pattern with the use of a commercially available silver etching solution, while causing the remaining photosensitive material (photoresist) to serve as a mask.

The following description further discusses the liquid crystal display device 21 of the embodiment in accordance with the present invention, with reference to FIG. 1.

As early described, the illumination device 31 included in the liquid crystal display device 21 of the embodiment in accordance with the present invention is a tandem type illumination device in which any adjacent two of the light guides 1 are provided so that a light emitting section 1b of one of the any adjacent two light guides 1 is provided above a light guide section 1a of the other of the any adjacent two light guides 1. It is necessary for the light guide 1 to suppress and minimize a loss of light in the light guide section 1a so that the light, that has entered the entrance surface 1d which faces the light source 2, is efficiently emitted via the emission surface 1c.

Since an upper face and a lower face of the light guide section 1a are provided so as to be substantially in parallel with each other, the light which has entered the entrance surface 1d is guided in the light guide section 1a while satisfying a total reflection condition. It is therefore possible to maintain amount of light.

Moreover, the emission surface 1c is provided so as to be substantially in parallel with the optical member 6 (see FIG. 1). It is therefore possible to secure a uniform distance between the optical member 6 and the respective emission surfaces 1c, in a case of designing a surface illuminant device 41 which carries out uniform surface emission by combining the optical member 6 with the illumination device of the present embodiment. This brings about an advantage of simplifying an optical design for uniformizing surface emission.

Furthermore, any adjacent two of the light guides 1 are provided so as to overlap each other at a slant with respect to the optical member 6 toward which the light is directed. Accordingly, in each of the light guides 1, the emission surface 1c is not in parallel with a surface opposite to the emission surface 1c. In other words, the light emitting section 1b has a shape which becomes thinner as a distance from the light source 2 increases, i.e., the emission surface 1c comes closer to the surface opposite to the emission surface 1c as the distance from the light source 2 increases.

According to the configuration, the light which has been guided in the light guide 1 gradually fails to meet the total reflection condition as a distance from the light source 2 increases, and the light is ultimately emitted from the emission surface 1c.

It is preferable that a surface (emission surface 1c) or a back surface of the light emitting section 1b is subjected to a process (fine concavity and convexity process) or a treatment in order to cause guided light to be emitted. Such a process or treatment can be, for example, a prism process, texturing, or a printing treatment. However, the present embodiment is not limited to those described above, and therefore a known method can be used as appropriate.

The light guide 1 can be made of a transparent resin such as polycarbonate (PC) or polymethyl methacrylate (PMMA). However, the present embodiment is not limited to this, and therefore the light guide 1 can be made of a material which is generally used as that of a light guide. The light guide 1 can be formed by a method such as injection molding, extrusion molding, heat-press molding, or cutting. However, the present embodiment is not limited to these methods, and therefore any processing method can be used, provided that it allows the light guide 1 to achieve similar property.

Each of the light sources 2 is provided along an edge part of an entrance surface 1d of a corresponding one of the light guides 1 (see FIGS. 1 through 3). According to the present embodiment, a light emitting diode (LED) which is a point light source is used as each of the light sources 2. Note, however, that a type of the light source is not limited to a specific one.

Alternatively, a combination of a plurality of kinds of light emitting diodes, each of which emits light in a different color, can be used as the light source 2. Specifically, it is possible to use an LED group of at least three light emitting diodes of red (R), green (G), and blue (B). In a case where a combination of the light emitting diodes of the three colors is used as the light source 2, white light can be emitted from the emission surface 1c.

Note that such a combination of colors of the light emitting diodes can be determined as appropriate based on properties such as (i) color properties of LEDs having respective colors and (ii) a desired color property which the surface illuminant device 41 is desired to have in accordance with an intended use of the liquid crystal display device 21. Note that it is possible to use a side-emitting LED in which LED chips of respective different colors are molded in a single package. This makes it possible to obtain an illumination device 31 having a wide color reproduction range.

Each of the reflection sheets 3 is provided so as to cover a surface opposite to an emission surface 1c of a corresponding one of the light guides 1 (see FIGS. 1 and 2).

Each of the reflection sheets 3 reflects light which leaks out of the surface opposite to an emission surface 1c of a corresponding one of the light guides 1 so as to return the light toward the corresponding one of the light guides 1. Each of the reflection sheets 3 serves as improving light use efficiency of a corresponding one of the light guides 1. More specifically, in each of the light guides 1, the reflection sheet 3 (i) causes light to enter the surface opposite to the emission surface 1c at a critical angle of total reflection or smaller with respect to a normal line of the surface opposite to the emission surface 1c, which critical angle depends on a material of the light guide 1 and (ii) reflects the light which leaks out of the light guide 1 so as to return the light toward the light guide 1.

According to the configuration, the reflection sheet 3 reflects the light, which leaks out of the surface opposite to the emission surface 1c of the light guide 1, so as to return the light to the light guide 1. Each of the reflection sheets 3 therefore serves as improving the light use efficiency of a corresponding one of the light guides 1.

Therefore, according to the configuration, it is possible to provide an illumination device 31 which achieves high light use efficiency.

According to the so-called tandem type illumination device 31, the reflection sheet 3 is provided so as to cover a surface which faces the emission surface 1c of the light guide 1 in each of the light guides 1. It is preferable in each of the light guides 1 that the reflection sheet 3 has a double-sided reflection function, when taking into consideration a loss in amount of the light, out of the light emitted from the exit surface 2a of the light source 2, which is reflected by the reflection sheet 3 and then enters the entrance surface 1d (see FIG. 2).

According to the configuration, the reflection sheet 3 is a double-sided reflection sheet. As such, the reflection sheet 3 serves as at least partially reflecting light, which leaks out of an upper surface (a surface on the emission surface 1c side) of one of the any adjacent two light guides 1 toward a back surface of the other of the any adjacent two light guides 1, so as to return the light to the one of the any adjacent two light guides 1. This makes it possible to further improve light use efficiency of each of the light guides 1.

Note that a general light guide causes light, which is emitted from a light source, to be subjected to repeated total reflections on inner surfaces of the light guide so that the light is guided toward an emission surface. In contrast, the light, which enters the upper surface at a critical angle of total reflection or smaller, leaks outside (i.e., leaks toward the other of the any adjacent two light guides 1) without being subjected to a total reflection on the upper surface of the one of the any adjacent two light guides 1. Note that the critical angle of total reflection is determined in accordance with a material of the light guide 1. In view of the circumstances, the double-sided reflection sheet is used to at least partially reflect the light, which leaks out of the upper surface of the light guide 1, so as to at least partially return the light toward the light guide 1.

Therefore, in a case where the reflection sheets 3 are double-sided reflection sheets, it is possible to suppress occurrence of a difference between respective amounts of light entering the entrance surfaces 1d of the respective light guides 1, even though a gap G between the respective exit surfaces 2a of the light sources 2 and the respective entrance surfaces 1d of the light guides 1 is uneven. Accordingly, it is possible to provide an illumination device 31 which can further improve luminous uniformity in the emission surface.

It is preferable that the reflection sheet 3 is attached to the light guide 1 via an adhesion layer 8 (adhesive member) (see FIGS. 1 and 2).

In a case where there is a gap between the reflection sheet 3 and the back surface of the light guide 1, luminous efficiency is decreased. This is because a loss of light becomes greater than a case where there is no gap. The luminous efficiency can be therefore further improved by adhering the reflection sheet 3 to the back surface of the light guide 1 via the adhesion layer 8 (adhesive member).

In order to improve the luminous efficiency by adhering the reflection sheet 3 to the back surface of the light guide 1, the reflection sheet 3 can be bonded, with the adhesion layer 8 (adhesive member), on an edge part of the surface opposite to the emission surface 1c of the light guide 1.

With the configuration, it is possible to provide an illumination device 31 which allows an improvement in luminous efficiency.

Note that a type of the adhesion layers 8 (adhesive members) is not limited to a specific one. However, it is preferable that each of the adhesion layers 8 is made of a transparent material, when taking into consideration light use efficiency.

The substrate 4 is, for example, a PWB (Printed Wiring Board) substrate on which the light sources 2 are provided. It is preferable that the substrate 4 is white in order to improve luminance. Note that a driver (not illustrated), that controls LEDs which constitute the light sources 2 to turn on or off, is provided on a back surface (which is opposite to a surface on which the light sources 2 are provided) of the substrate 4. That is, the driver is provided on the substrate 4 on which the LEDs are provided. This makes it possible to reduce the number of substrates and to reduce components such as connectors for connecting one substrate another. Accordingly, it is possible to reduce cost of the device. Moreover, the number of the substrates is small, and it is therefore possible to reduce a thickness of the liquid crystal display device 21.

According to the present embodiment, a transmissive liquid crystal display panel which carries out a display by transmitting light which is emitted from the surface illuminant device 41 (backlight) is used as the liquid crystal display panel 5.

Note that the configuration of the liquid crystal display panel 5 is not limited to a specific one, and therefore a known liquid crystal panel can be used as appropriate. Even though not illustrated, the liquid crystal display panel 5 includes, for example, (i) an active matrix substrate on which a plurality of TFTs (thin film transistors) are provided, (ii) a color filter substrate which faces the active matrix substrate, and (iii) a liquid crystal layer which is sealed between the substrates with a sealing material.

The optical member 6 is made up of a diffusing plate and a multi-functional optical sheet. The multi-functional optical sheet has a plurality of optical functions selected from various optical functions including diffusion, refraction, converging of light, and polarization of light.

For example, a diffusing plate which has a thickness of approximately 2 mm to 3 mm and is provided so as to be away, by several millimeters, from the illumination device 31 can be employed as the optical member 6. Note, however, that the thickness of the diffusing plate and the distance by which the diffusing plate is away from the illumination device 31 are not limited to those described above.

The diffusing plate (i) is provided so as to face the emission surface and cover an entire emission surface which is made up of the emission surfaces 1c which are juxtapose to each other and (ii) is provided away, by a predetermined distance, from the emission surface. The diffusing plate diffuses light which is emitted from the emission surface.

It is possible to further provide, on the upper surface of the diffusing plate, for example, a multi-functional optical sheet such as a diffusing sheet having a thickness of approximately several hundreds micrometers, a prism sheet, or a polarizing reflection sheet so as to secure luminous uniformity which is sufficient for the surface illuminant device 41 to carry out its function. The thickness and the configuration are merely illustrative, and the present embodiment is therefore not limited to these.

The multi-functional optical sheet is made up of a plurality of sheets which are stacked on a front-face side of the light guides 1. The multi-functional optical sheet uniformizes and converges the light emitted from the emission surfaces 1c of the light guides 1 so that the liquid crystal display panel 5 is irradiated with the light thus uniformized and converged.

That is, the multi-functional optical sheet can be a sheet such as (i) a diffusing sheet which scatters light while converging, (ii) a lens sheet which improves luminance of light in frontward direction (a direction pointing the liquid crystal display panel 5) by converging the light, and/or (iii) a polarizing reflection sheet which improves luminance of the liquid crystal display device 21 by reflecting one polarization component of light while causing the other polarization component to transmit. It is preferable that the sheets (i) through (iii) are used in combination as appropriate, in accordance with a cost and properties of the liquid crystal display device 21.

The surface illuminant device 41 included in the liquid crystal display device 21 thus includes the optical member 6 as described above.

With the configuration, it is possible to provide a surface illuminant device 41 which can further improve luminous uniformity in the emission surface.

A television receiver of the embodiment in accordance with the present invention includes the liquid crystal display device 21. This makes it possible to provide a television receiver which is thin and has an excellent display quality.

### Embodiment 2

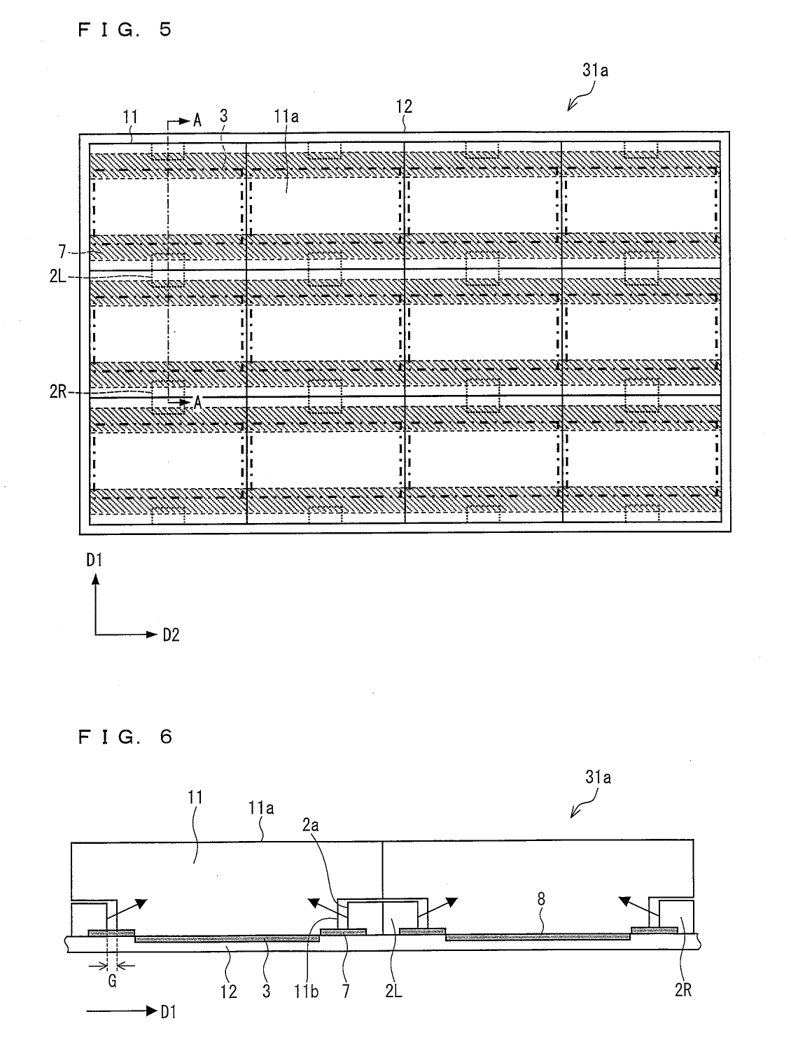

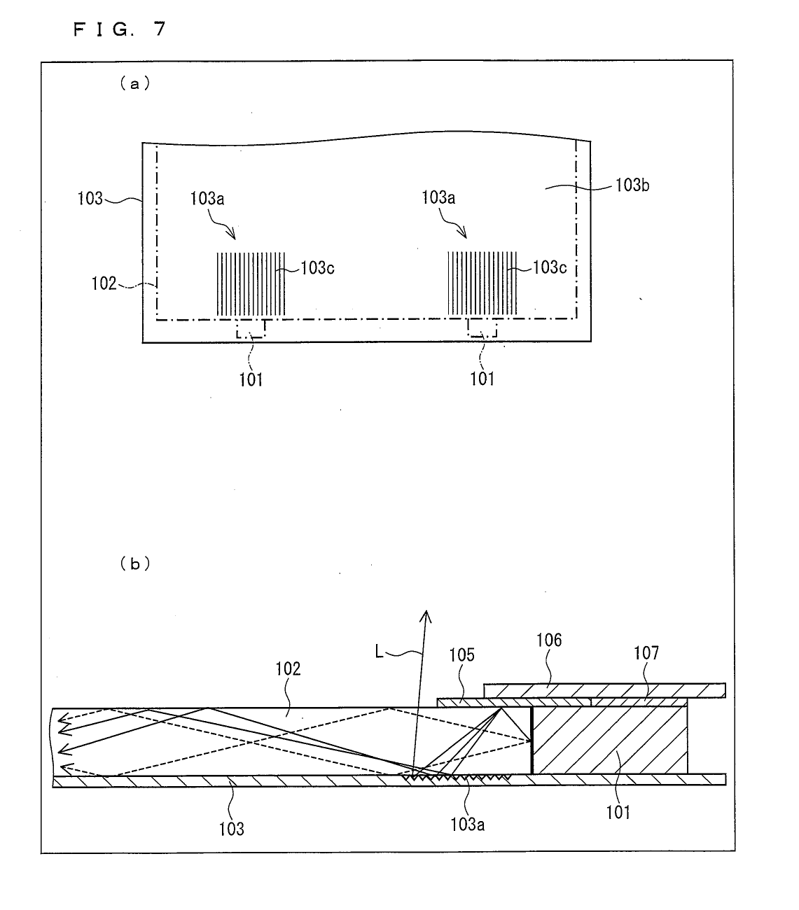

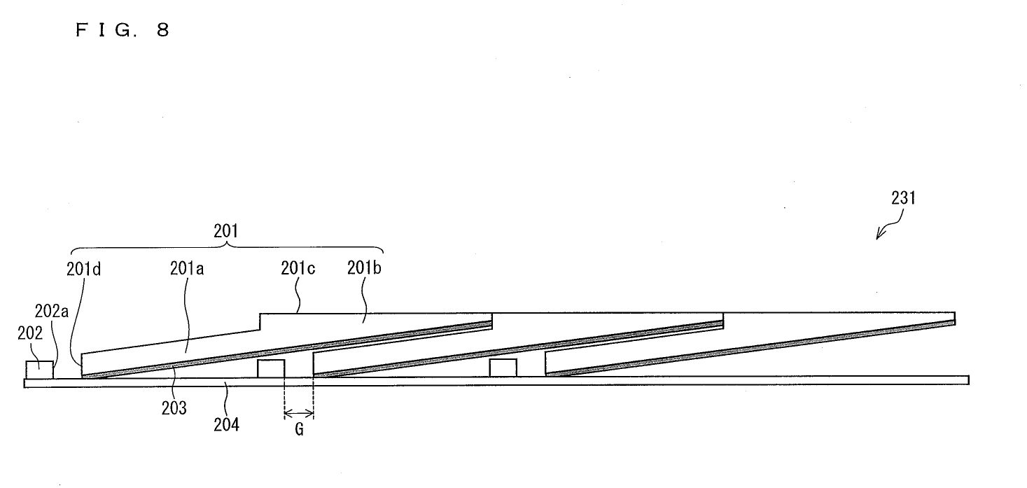

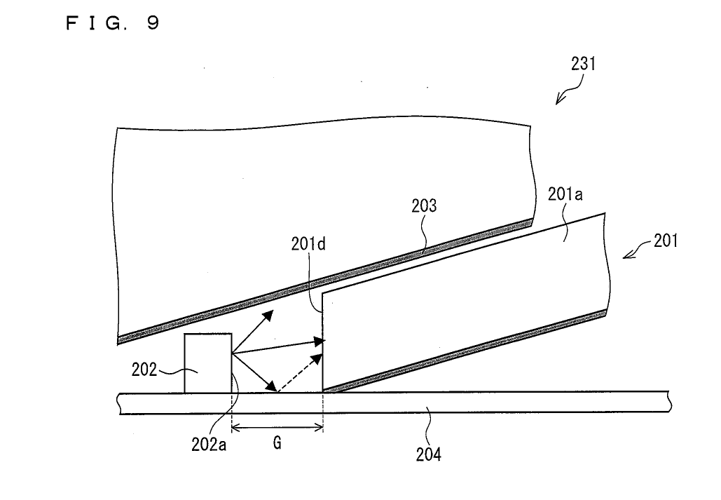

The following describes Embodiment 2 of the present invention with reference to FIGS. 5 and 6. Note that configurations which are not described in this embodiment are similar to those of Embodiment 1. Moreover, for convenience, the same reference numerals are given to members which have functions identical to those shown in the drawings of Embodiment 1, and descriptions of such members are omitted here.

FIG. 5 is a front view illustrating an illumination device 31a included in a television receiver of the present embodiment in accordance with the present invention, when viewed from an emission surface 11a side.

FIG. 6 is a cross sectional view of the illumination device 31a, taken on line A-A of FIG. 5.

Each light guide 11 causes light, which is supplied from a corresponding one of light sources 2, to be emitted from a corresponding one of the emission surfaces 11a. Note that an emission surface, which is made up of emission surfaces 11a which are juxtaposed to each other, is a surface for emitting light toward a target object.

According to the present embodiment, the number of the light guides 11, which constitute the illumination device 31a, is at least two. That is, the illumination device 31a is configured so that a plurality of combinations, each including a corresponding one of the light guides 11 and a corresponding one of the light sources 2, which are juxtaposed to each other on a single plane.

Moreover, according to the illumination device 31a of the present embodiment, the light guides 11 are juxtaposed to each other on a single plane, i.e., on a substrate 12 so as not to overlap each other (see FIGS. 5 and 6). Accordingly, emission surfaces 11a of the respective light guides 11 define a uniplanar emission surface.

The light guides 11, for respective of which two light sources 2L and 2R (a pair of light sources) are provided, are arranged lengthwise and breadthwise (see FIG. 5). The light guides 11, each of which has the two light sources 2L and 2R, are provided as if the substrate 12 is paved with tiles. Therefore, the illumination device 31a thus arranged is called a tiled illumination device.

The present embodiment is exemplified by the arrangement where each of the two light sources 2L and 2R is provided in a vicinity of a center of a corresponding one of two sides, which face each other, of a corresponding one of the light guides 11 which has a rectangular shape. It is, however, possible to select as appropriate the number and locations of the respective light sources if necessary.

Note that a direction in which the two light sources 2L and 2R face each other in the light guide 11, which has a rectangular shape, is assumed to be a first direction D1, and a direction which intersects (at substantially right angles) with the first direction D1 on the substrate 12 is assumed to be a second direction D2 (see FIG. 5).

The light sources 2L and 2R are (i) provided in respective depressed parts, which are cavities, formed in the light guide 11 and (ii) provided so as to face each other (see FIG. 6). In each of the light guides 11, the light sources 2L and 2R are provided so that the light emitted from one of the light sources 2L and 2R is directed toward the other of the light sources 2L and 2R (see FIG. 6).

Namely, in each of the light guides 11, the light source 2L and the light source 2R are provided so as to face each other and so that the light emitted from each of the light sources 2L and 2R enters the light guide 11. This allows light to be emitted from the entire emission surface 11 a of each of the light guides 11 while emission regions of the light sources 2L and 2R overlapping each other. Since the present embodiment employs such an illumination device 31a, it is possible to provide a large backlight which has no dark part.

It is preferable that a reflection sheet 3 is adhered to the light guide 11 via an adhesion layer 8 (adhesive member) (see FIG. 6), for the foregoing reasons.

According to the configuration of each of the light guides 11, the light emitted from each of the light sources 2L and 2R (i) travels inside the light guide 11 while being scattered and reflected repeatedly, (ii) exits from the emission surface 11a, (iii) passes through the optical member 6 described early, and ultimately (iv) reaches the liquid crystal display panel 5.

However, according to the illumination device 31a which is the tiled illumination device, there is a gap G between the respective entrance surfaces 11b of the light guides 11 and respective exit surfaces 2a, each of which faces corresponding one of the entrance surfaces 11b, of the light sources 2L and the light sources 2R (see FIG. 6), as with the foregoing tandem type illumination device. The gaps G become uneven due to causes such as (i) positional displacement of the light guides 11, (ii) misalignment during mounting of the light sources 2L and the light sources 2R, (iii) manufacturing tolerances of the light guides 11, the light sources 2L, and the light sources 2R, and (iv) thermal expansion deviations caused by heat generated by the light sources 2.

According to the present embodiment, (i) the wiring pattern of the substrate 12 and (ii) the reflecting section 7 (early described in detail) which is formed linearly in the second direction D2, are concurrently formed by patterning (see FIGS. 5 and 6).

With the configuration, the reflecting sections 7, which are provided on the substrate 12, can minimize occurrence of a difference between respective amounts of light entering the entrance surfaces 11b of the respective light guides 11, even though the gaps G become uneven. That is, it is possible to provide an illumination device 31a which can (i) minimize a loss, caused by the substrate 12, in amount of light entering the entrance surfaces 11b of the respective light guide 11 and (ii) further improve luminous uniformity in the emission surface even though the gaps G are uneven.

The reflecting sections 7 are consecutively and linearly provided in the second direction D2 (see FIG. 5). According to the configuration, it is not necessary to carry out a fine patterning, and therefore the patterning can be carried out accurately. This makes it possible to suppress an effect of luminous unevenness caused by the accuracy of the patterning.

The present invention is not limited to the embodiments, but can be altered by a skilled person in the art within the scope of the claims. An embodiment derived from a proper combination of technical means disclosed in respective different embodiments is also encompassed in the technical scope of the present invention.

### INDUSTRIAL APPLICABILITY

The present invention can be applied to (i) an illumination device or (ii) a surface illuminant device each of which is used as a device such as a backlight of a television receiver or (iii) a display device or (iv) a television receiver each of which includes the illumination device or the surface illuminant device.

### REFERENCE SIGNS LIST

1 and 11: Light guide
1a: Light guide section
1b: Light emitting section
1c and 11a: Emission surface
1d and 11b: Entrance surface
2, 2L, and 2R: Light source
2a: Exit surface
4 and 12: Substrate
6: Optical member
7: Reflecting section
8: Adhesion layer (adhesive member)
21: Liquid crystal display device
31 and 31a: Illumination device
41: Surface illuminant device
H: Strip area
I and J: Demarcated area
D1: First direction
D2: Second direction

1. An illumination device comprising:
a plurality of combinations each of which includes (i) a light source having an exit surface and (ii) a light guide, having an entrance surface, which causes light emitted from the light source to diffuse and have a surface emission;
a substrate on which the light sources are provided; and
a reflecting section provided in at least part of a strip area, on the substrate, between the exit surface and the entrance surface, the strip area having (i) a first distance, equal to a distance between the exit surface and the entrance surface, in a first direction and (ii) a second distance in a second direction,
the first direction extends in a direction in which the exit surface and the entrance surface face each other, and the second direction being perpendicular to the first direction on the substrate.

2. The illumination device as set forth in claim 1, wherein:
said at least part of the strip area is in an area defined by connecting four points, (i) two of which are on the substrate and correspond to both ends of the entrance surface in the second direction and (ii) two of which are on the substrate and correspond to both ends of the exit surface in the second direction.

3. The illumination device as set forth in claim 1, wherein:
said at least part of the strip area is in an area defined by two lines, (i) one of which extends to the entrance surface, in the first direction, from a corresponding one of two points on the substrate which corresponds to one of both ends of the exit surface in the second direction and (ii) the other of which extends to the entrance surface, in the first direction, from the other of the two points on the substrate which corresponds to the other of the both ends of the exit surface.

4. The illumination device as set forth in claim 1, wherein:
the light guide has (i) a light emitting section having an emission surface and (ii) a light guide section which guides the light from the light source toward the light emitting section; and
the exit surfaces are provided so as to be two-dimensionally juxtaposed to each other on the surface of the substrate.

5. The illumination device as set forth in claim 1, wherein:
ones of the light guides, which are provided so as to be two-dimensionally juxtaposed to each other, are provided in one of two directions so that a light emitting section of one of any adjacent two light guides is provided above a light guide section of the other of the any adjacent two light guides.

6. The illumination device as set forth in claim 1, wherein:
the light guides which (i) are provided so as to be two-dimensionally juxtaposed to each other and (ii) are provided so that any adjacent ones of the light guides do not overlap each other.

7. The illumination device as set forth in claim 1, wherein:
each of the light sources is an LED which is provided on the substrate.

8. The illumination device as set forth in claim 1, wherein:
the reflecting section and a wiring pattern of the substrate are formed by patterning a layer made of an identical material.

9. The illumination device as set forth in claim 1, wherein:
the reflecting sections are consecutively and linearly provided along the light guides which are provided in the second direction.

10. The illumination device as set forth in claim 1, wherein:
the reflecting section has a width, in the first direction, which is set so as to be larger than a sum of the first distance and a maximum tolerance of the first distance.

11. The illumination device as set forth in claim 1, wherein:
a reflection sheet is provided in the light guide so as to cover a surface which is opposite to the emission surface.

12. The illumination device as set forth in claim 11, wherein:
the reflection sheet is a double-sided reflection sheet.

13. The illumination device as set forth in claim 11, wherein:
the reflection sheet is attached to the light guide via an adhesive member.

14. A surface illuminant device in which an optical member is provided on an emission surface of an illumination device recited in claim 1.

15. A display device comprising:
a surface illuminant device recited in claim 14; and
a display panel which carries out a display with use of light emitted from the surface illuminant device.

16. The display device as set forth in claim 15, wherein:
the display panel is a liquid crystal panel in which liquid crystal is sealed between a pair of substrates.

17. A television receiver comprising a display device recited in claim 16.

18. The illumination device as set forth in claim 4, wherein:
ones of the light guides, which are provided so as to be two-dimensionally juxtaposed to each other, are provided in one of two directions so that a light emitting section of one of any adjacent two light guides is provided above a light guide section of the other of the any adjacent two light guides.
